(19) United States
(12) Patent Application Publication
(10) Pub. No.: US 2017/0077854 A1
(43) Pub. Date: Mar. 16, 2017

(54) METHOD AND APPARATUS FOR CONTROLLING AN ELECTRIC MACHINE

(71) Applicant: GM GLOBAL TECHNOLOGY OPERATIONS LLC, Detroit, MI (US)

(72) Inventors: Yo Chan Son, Rochester Hills, MI (US); Brian A. Welchko, Oakland, MI (US); Dwarakanath V. Simili, Novi, MI (US); Mohammad Faizul Momen, Rochester Hills, MI (US); Aayush Gupta, Rochester Hills, MI (US); Chia-Chou Yeh, Novi, MI (US)

(73) Assignee: GM GLOBAL TECHNOLOGY OPERATIONS LLC, Detroit, MI (US)

(21) Appl. No.: 14/854,171

(22) Filed: Sep. 15, 2015

(51) Int. Cl. H02P 21/00; H02P 27/08; H02P 6/10

(52) U.S. Cl. CPC H02P 21/0035; H02P 6/10; H02P 27/08

(57) ABSTRACT

A multi-phase electric machine electrically connected to an inverter is described. A method for controlling the electric machine includes determining an initial current command responsive to a torque command for the electric machine and determining an expected torque ripple associated with operation of the electric machine. A mitigation current command is determined based upon the torque command and the expected torque ripple, and the electric machine is dynamically controlled responsive to the initial current command and the mitigation current command.

### TECHNICAL FIELD

The present disclosure generally relates to multi-phase electric machines, and operation and control thereof.

### BACKGROUND

Motor vehicles may employ electrically-powered traction drive systems including electric machines that supplement or supplant traction torque from internal combustion engines.

In hybrid-electric and electric vehicle applications, an electric machine often directly couples to driveline components without intervening vibration damping elements such as a torque converter. Such configurations exhibit torque responsiveness with minimal energy loss. Electric machines including permanent magnet machines and synchronous motor machines experience variable inductance between the rotor and stator due to the geometric structure and non-sinusoidal distribution of electro-magnetic forces, which generate harmonic components causing torque fluctuation, which may also be referred to as torque ripple. Torque ripple in the electric machine may propagate through the driveline and cause speed fluctuations and vehicle oscillation and other undesirable effects that may be discerned by a vehicle passenger.

### SUMMARY

A multi-phase electric machine electrically connected to an inverter is described. A method for controlling the electric machine includes determining an initial current command responsive to a torque command for the electric machine and determining an expected torque ripple associated with operation of the electric machine. A mitigation current command is determined based upon the torque command and the expected torque ripple, and the electric machine is dynamically controlled responsive to the initial current command and the mitigation current command.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIG. 1 schematically illustrates a multi-phase electric machine that is electrically coupled to an inverter module, in accordance with the disclosure;

FIG. 2 graphically shows an example of a torque ripple generated by operation of one embodiment of the electric machine, in accordance with the disclosure;

FIG. 3 schematically shows a torque ripple mitigation calibration process for determining a torque ripple mitigation calibration, in accordance with the disclosure;

FIG. 4 depicts one example of a torque ripple mitigation calibration table, in accordance with the disclosure; and

FIG. 5 illustrates an electric machine drive system for control operation of an embodiment of the inverter electrically connected to the electric machine, in accordance with the disclosure.

### DETAILED DESCRIPTION

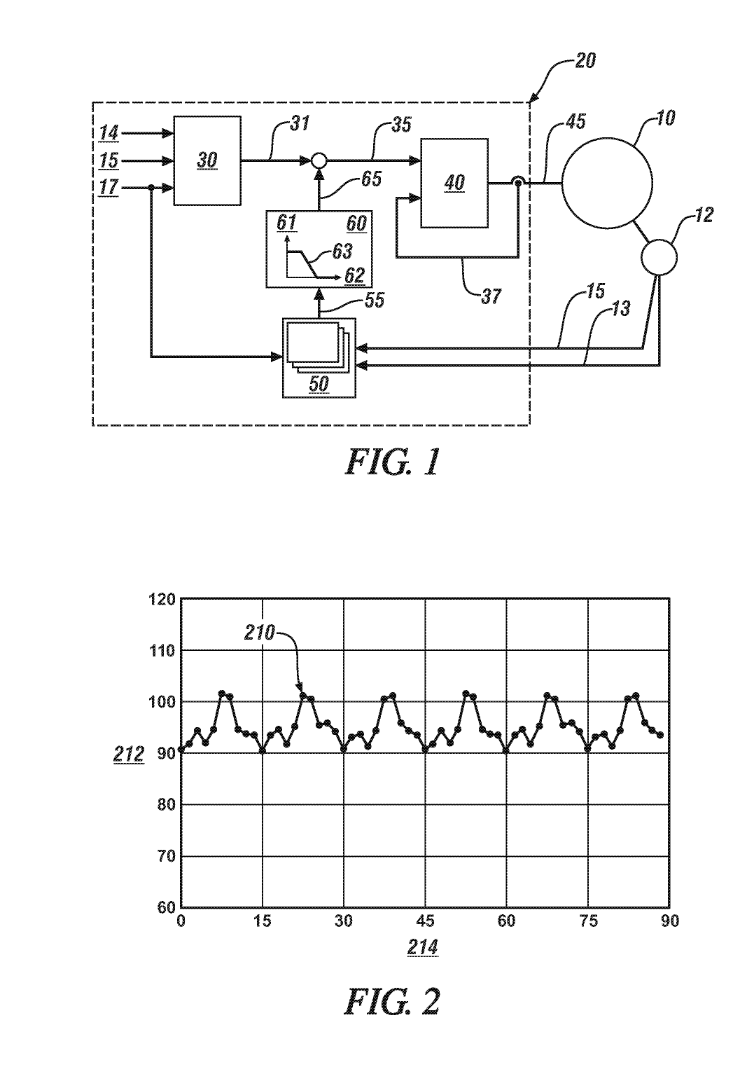

Referring now to the drawings, wherein the depictions are for the purpose of illustrating certain exemplary embodiments only and not for the purpose of limiting the same, FIG. 1 schematically illustrates a multi-phase electric machine (electric machine) 10 that is electrically coupled to an inverter module 20, in accordance with one embodiment of the disclosure. The electric machine 10 includes a rotor and a stator, and the rotor may couple to an output member that may couple to a rotatable driveline component to supply tractive torque to a vehicle wheel in one embodiment.

As described herein, the inverter module 20 includes suitable hardware components, electronic controllers, memory devices and related routines that are electrically and/or signally combined to control operation of the electric machine 10 in response to a torque command 17 while mitigating expected torque ripple related to design and operation of the electric machine 10. The inverter module 20 monitors rotational speed 15 and rotor position 13 of the rotor of the electric machine 10 and generates and communicates PWM voltage commands 45 to the electric machine 10 to control its operation. The inverter module 20 includes a current controller 30, a current-shaping module 50 and a speed-based gain compensation module 60 that interact to generate a speed-compensated mitigation current command 65 that is injected into an initial current command 31 to determine a feed-forward current command 35 that is communicated to the inverter 40. The inverter 40 generates the PWM voltage commands 45 and monitors PWM current signals 37 to control electric power flow from a high-voltage electric power source to the electric machine 10 including mitigating torque disturbances associated with the expected torque ripple related to operation of the electric machine 10, wherein the expected torque ripple is dependent upon the rotor speed 15 and rotor position 13 of the electric machine 10 and includes position-based perturbations that are associated with multiple harmonic frequencies.

The electric machine 10 is preferably a multi-phase alternating current motor/generator device that includes a stator assembly and a concentric rotor assembly that may be arranged with multiple magnetic poles, and may be configured as an induction motor, a permanent magnet motor, or another suitable configuration. Rotor position of the electric machine 10 is preferably monitored with a suitable position sensor 12, which preferably includes a position sensing transducer such as a resolver or a Hall effect device. The position sensor 12 preferably includes electronic circuitry and/or a controller that interprets a raw signal from the position sensing transducer and generates electric signals indicating the motor position 13 and motor speed 15.

The current controller 30, the current-shaping module 50 and the speed-based gain compensation module 60 of the inverter module 20 are one embodiment of an architecture to accomplish the functions described therewith. In this regard, each module may be implemented by a special purpose hardware-based system that performs the specified functions or acts, or combinations of special purpose hardware and memory devices including executable instruction sets. The current controller 30 generates the initial current command 31 to generate torque responsive to the torque command 17, taking into account the motor speed 15 and a voltage level 14 of a high-voltage DC power bus supplying electric power to the inverter 40, employing torque/current relationships that are specific to the design and operation of the electric machine 10 and the inverter 40. The current-shaping module 50 generates a mitigation current command 55 based upon a rotor position of the electric machine 10, the torque command and the expected torque ripple for the electric machine 10. An example of the expected torque ripple for the electric machine 10 is described with reference to FIG. 2.

FIG. 2 graphically shows a non-limiting example of a torque ripple 210 generated by operation of one embodiment of the electric machine 10. FIG. 2 shows torque fluctuation (Nm) on the vertical axis 212 in relation to the rotor position (degrees of mechanical rotation) of the rotor on the horizontal axis 214 for a selected torque command and motor temperature. As appreciated, the torque ripple 210 includes torque perturbations associated with multiple harmonic frequencies that may occur each rotor position of the electric machine. The magnitude of the torque ripple 210 of the electric machine 10 and is related to arrangement of stator slots, electrical winding patterns and resulting non-linearity of magnetic flux that cause position-based torque perturbations at each rotor position and torque command, and may be associated with multiple harmonic frequencies. Thus an expected torque ripple is a characteristic of a specific design of the electric machine 10. At lower motor speeds, the torque ripple may excite the resonance of specific components of a vehicle structure such as a mount or frame element, causing torque and speed pulsations that are discernible to a vehicle occupant.

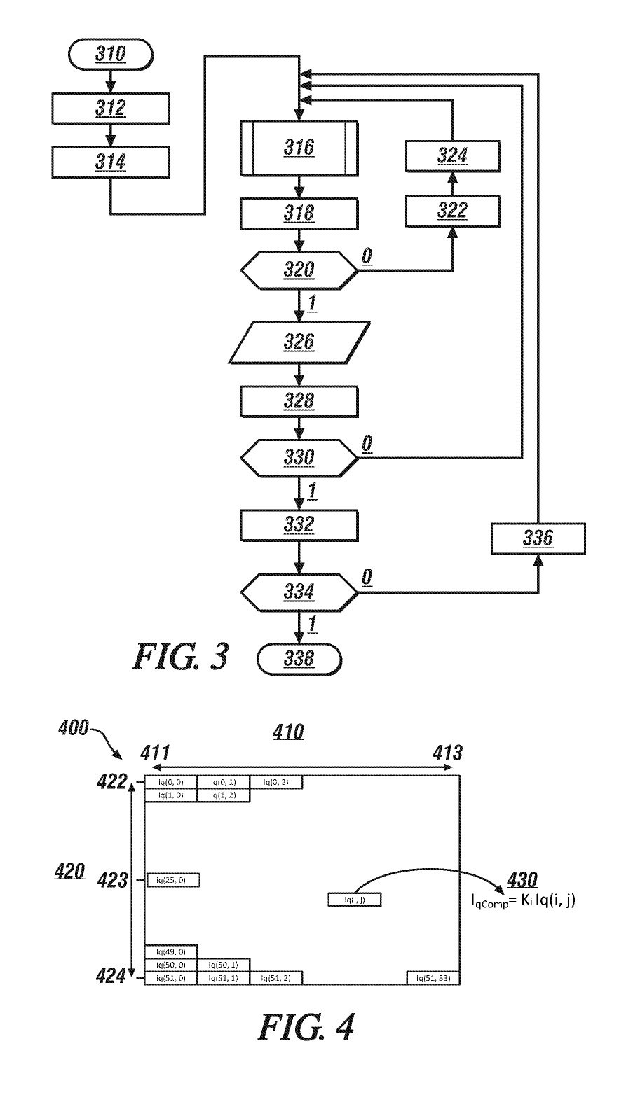

The mitigation current command 55 may be selected or otherwise determined from a calibration algorithm based upon the torque command 17, the motor speed 15 and the motor position 13. A process to determine the mitigation current command 55 is described with reference to FIGS. 3 and 4.

The mitigation current command 55 is input to the speed-based gain compensation module 60 to generate the speed-compensated mitigation current command 65 to mitigate torque disturbances introduced by operation of the electric machine 10. The speed-compensated mitigation current command 65 is responsive to the expected torque ripple and is injected into the initial current command 31 to determine a feed-forward current command 35 that is communicated to the inverter 40 to generate the PWM voltage commands 45 for controlling the electric machine 10, including a control architecture for injecting the speed-compensated mitigation current command 65 into the initial current command 31 to determine a feed-forward current command 35 that is communicated to the inverter 40.

The speed-based gain compensation module 60 is based upon a predetermined relationship between a correction factor on the vertical axis 61 and an absolute value of the motor speed on the horizontal axis 62 for the embodiment of the electric machine 10, wherein the maximum torque 63 available from the electric machine 10 is determined in relation to the absolute value of the motor speed. The maximum torque 63 has a maximum gain over a range of low speeds, and reduces when the absolute value of the absolute value of the rotor speed is greater than a speed threshold. The relationship between motor torque and rotor speed is a performance characteristic that is specific to the embodiment of the electric machine 10. The relationship for the maximum torque 63 is depicted for a nominal positive torque and nominal positive direction of speed. It is appreciated that the speed-based gain compensation module 60 as implemented includes a maximum torque for a nominal negative torque and a nominal positive direction of speed, a maximum torque for a nominal negative torque and nominal negative direction of speed, and a maximum torque for a nominal positive torque and nominal negative direction of speed. As employed herein, positive torque relates to motor torque in which the electric machine 10 is providing torque to an output member for tractive or propulsion effort, and negative torque relates to generator torque in which the output member is providing torque to the electric machine 10 for reacting to generate electric power.

The inverter 40 preferably includes a plurality of switch devices arranged as switch pairs that electrically connect in series between a positive high-voltage DC power bus and a negative high-voltage DC power bus, wherein the power buses electrically connect to a high-voltage DC power source. Each of the switch pairs corresponds to a phase of the electric machine 10, with the first switch connecting in series with the corresponding second switch at a node, and the nodes electrically connecting to nominal first, second and third phases of the electric machine 10 to transfer electric power thereto. Gate drive circuits control activation and deactivation of the switch pairs. A controller generates control signals that are communicated to the gate drive circuits to activate and deactivate the switches in response to an inverter switch control mode that can include a pulsewidth-modulated (PWM) mode, a six-step control mode or another suitable switch control mode. The inverter 40 includes other electrical components including capacitors, resistors, and other electrical circuit components to accomplish functions related to electrical noise suppression, load balancing and the like. The switches may be Insulated Gate Bipolar Transistors (IGBTs), Junction Field-Effect Transistors (JFETs), Silicon-Carbide (SiC) JFETs, or other suitable high current switch devices.

The terms controller, control module, module, control, control unit, processor and similar terms refer to any one or various combinations of Application Specific Integrated Circuit(s) (ASIC), electronic circuit(s), central processing unit(s), e.g., microprocessor(s) and associated non-transitory memory component in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, routines, code, algorithms and similar terms mean any controller-executable instruction sets including calibrations and look-up tables. Each controller executes routine(s) to provide desired functions, including monitoring inputs from sensing devices and other networked controllers and executing control and diagnostic instructions to control operation of actuators. Routines may be executed at regular intervals, for example each 100 microseconds or 3.125, 6.25, 12.5, 25 and 100 milliseconds during ongoing operation. Alternatively, routines may be executed in response to occurrence of a triggering event. Communication between controllers, and communication between controllers, actuators and/or sensors may be accomplished using a direct wired link, a networked communications bus link, a wireless link or another suitable communications link. Communication includes exchanging data signals in any suitable form, including, for example, electrical signals via a conductive medium, electromagnetic signals via air, optical signals via optical waveguides, and the like. Data signals may include signals representing inputs from sensors, signals representing actuator commands, and communications signals between controllers. The term ‘model’ refers to a processor-based or processor-executable routine and associated calibration that simulates a physical existence of a device or a physical process. As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

FIG. 3 schematically shows one embodiment of a torque ripple mitigation calibration process (process) 300 for determining a torque ripple mitigation calibration, which may be reduced to practice as one or a plurality of torque ripple mitigation calibration tables for an embodiment of the electric machine 10. FIG. 4 depicts one example of a torque ripple mitigation calibration table 400. Overall, the process 300 includes generating a look-up table of torque values from a Finite Element Analysis (FEA) simulation of the electric machine 10. For every torque and rotor position, the FEA simulation generates an instantaneous torque that is generated by the electric machine 10 as modeled. The average torque is obtained by averaging the torque across the rotor position at the same torque command level. Ideally, the average torque is equal to the torque command. The instantaneous torque is subtracted from the torque command at the specific rotor position to determine a torque error at the position. The mitigation current command is adjusted as the following equation:

I_{qComp}(T*,θ)|ₖ₊₁=I_{qComp}(T*,θ)|ₖ+α·(T*−Tₖ) [1]

wherein I_{qComp} is a compensation current, i.e., a mitigation current,
k indicates an iteration step,
T* indicates the torque command (=Average Torque),
θ indicates rotor position,
Tₖ indicates calculated torque at k-th step, and
α indicates a convergence factor.

The compensation current I_{qComp} is injected to the q-axis current command for next cycle's FEA simulation. The iteration stops when the torque error is less than the predefined threshold. This process repeats for every position and torque command step.

The position range of the FEA simulation depends on the harmonic order of the torque ripple. Known three-phase AC motors generate multiples of 6^{th} order harmonics of torque ripple with respect to the fundamental electrical frequency. (6^{th}, 12^{th}, 18^{th}, . . . ). If the minimum order of the torque ripple is the 6^{th} order harmonic, then the simulation can restrict the range of the simulation between 0 and 60 degrees of the electrical position. As shown in FIG. 4 as an example, the table 400 provides 33 steps associated with the electrical position of the embodiment of the electric machine 10. In this case, when the torque ripple mitigation calibration table 400 is populated for an embodiment of the electric machine 10 as described above, the remaining calibration values are dynamically adjusted. Table 1 is provided as a key wherein the numerically labeled blocks and the corresponding functions are set forth as follows, corresponding to the process 300.

TABLE 1

| BLOCK | BLOCK CONTENTS |
|---|---|
| 310 | Start |
| 312 | Set TrqCmd = Tmin |
| | Set Rotor_Pos = 0 |
| 314 | Prepare average torque and current |
| | command |
| 316 | Calculate motor torque from FEA |
| | simulation |
| 318 | Calculate torque error |
| | Trq_Err = (Average Torque) − (Calculated |
| | Torque) |
| 320 | Is \|Trq_Err\| < Threshold? |
| 322 | Determine new current compensation value |
| | from Trq_Err |
| 324 | Determine new current value from current |
| | compensation |
| 326 | Store current compensation value as |
| | mitigation current command for Trq_Cmd, |
| | Rotor_Pos |
| 328 | Index Rotor_Pos |
| 330 | Is Rotor_Pos > Max_Pos? |
| 332 | Index Trq_Cmd |
| 334 | Is Trq_Cmd>Tmax? |
| 336 | Set Rotor_Pos = 0 |
| 338 | End |

At the start of a calibration for a specific embodiment of the electric machine 10 (310), the process sets the commanded motor torque to a minimum torque value (Set TrqCmd=Tmin) and sets the rotor position to zero (Rotor_Pos=0) (312). The minimum torque value Tmin corresponds to a largest magnitude of negative torque, which is the largest torque associated with operation of the electric machine 10 when it is operating in an electric power generating mode, such as during regenerative braking when the electric machine 10 couples to a rotatable driveline component to supply tractive torque to a vehicle wheel. A maximum torque value Tmax corresponds to a largest magnitude of positive torque, which is the largest torque associated with operation of the electric machine 10 when it is operating in a torque generating mode. An average torque command and an average current command are set, and represent nominal values to achieve the commanded motor torque (314). Ideally, the average motor torque is equal to the commanded motor torque.

FEA is employed to generate a model for the embodiment of the electric machine 10 for calculating motor torque in response to the torque command and the average current command (316). FEA can be employed simulate mechanical and electrical characteristics of the electric machine 10 operating under predetermined load conditions in response to torque commands at given speeds with specific current commands. An FEA simulation includes finite element model having thousands of finite triangular-shaped elements, called ‘mesh’ that relate to the mechanical and electrical structure of the electric machine. Motor performance related to torque, magnetic flux and other factors are solved for various conditions using the laws of electromagnetics and mechanics. Simulation results from FEA models are known to accurately reflect mechanical and electrical characteristics of an electric machine. Current-excitation in the FEA simulation is typically composed of two separate components, namely direct current Id and quadrature current Iq, wherein Id generally controls magnet flux and Iq controls motor torque. Through FEA simulation, Iq may be iteratively fine-tuned so that a given average torque is achieved by the electric machine 10 with a minimum torque ripple. As appreciated, the direct current Id and quadrature current Iq result from a mathematical transformation of a three-phase electrical system that may be employed to simplify analysis and control, often referred to as a Park transformation. Thus, FEA is employed to calculate the motor torque (316), and calculate a torque error (Trq_Err) (318)_as a difference between the calculated motor torque and the commanded motor torque (318). The torque error (Trq_Err) is compared with a threshold (320), and when greater than the threshold (320)(0), a new current compensation value is determined from the torque (322) according to Equation 1. The new current compensation value may be either positive or negative, depending upon whether the torque error is positive or negative. A new current command is determined by arithmetically combining the new current compensation value with the average current command (324), and the FEA model is employed to recalculate the motor torque with the new current command (316). This iterative process continues until the difference between the calculated motor torque and the commanded motor torque is less than the threshold error (320)(1).

When the difference between the calculated motor torque and the commanded motor torque is less than the threshold error (320)(1), the new current compensation value is captured and stored as a mitigation current command that is associated with the present torque command and the rotor position (326). A calibration state is captured and stored, and includes the present torque command, the rotor position and the mitigation current command (326). The rotor position is incremented by a predetermined step, e.g., 1.875 degrees of rotation (328), and the iterative process is re-executed to determine a new current compensation value for the rotor position (steps 316 through 326), until the rotor position advances to a maximum rotor position, which may be 60 degrees of rotation in one embodiment (330)(0). When the routine 300 has determined current compensation values across the rotor position from a minimum rotor position to a maximum rotor position for the commanded (330)(1), the routine 300 increments the commanded motor torque by a preset value, e.g., 1 Nm in one embodiment (332), resets the rotor position to 0 (336) and re-executes steps 316 through 330 to determine mitigation current commands across the rotor position from a minimum rotor position to a maximum rotor position for the commanded motor torque. This process iteratively executes to determine mitigation current commands across the rotor position from a minimum rotor position to a maximum rotor position for the commanded motor torque from the minimum torque Tmin to the maximum torque Tmax (334)(0), and then ends (334)(1), (338). The mitigation current commands populate the torque ripple mitigation calibration table 400, and are selectively employed as the mitigation current commands 55 during operation of the multi-phase electric machine 10 employing the inverter module 40 as described herein.

FIG. 4 graphically shows an exemplary torque ripple mitigation calibration table 400 that may be generated by executing the torque ripple mitigation calibration process (process) 300 described with reference to FIG. 3. The torque ripple mitigation calibration table 400 contains a plurality of mitigation current commands that may be selectable based upon motor torque and motor position. One of the mitigation current commands may be selected and added to the commanded current to provide smooth motor torque in response to a commanded motor torque, wherein the selected mitigation current command is determined based upon the commanded motor torque command and the motor position indicated by the rotor position 13. The torque ripple mitigation calibration table 400 includes motor torque on the vertical or Y-axis 410 and motor position on the horizontal or X-axis 420. In one embodiment, the X-axis 410 has 33 elements representing motor positions, in degrees of electrical rotation, for the associated harmonic current, and the Y-axis 420 has 51 elements corresponding to the torque command at zero speed. The input for indexing the X-axis 410 is calculated from the motor position and speed as follows:

(X axis input)=Kₚθ+KₙNᵣ+θ_{offset} [2]

wherein θ is the rotor position,
Nᵣ is a rotor speed,
Kₚ is a gain term to scale the motor position for look-up table,
Kₙ is a gain term related to the dependency on the operating speed,
θ offset is an offset term to shift the index for the ease of the calibration.

As an example, the input to the X-axis 410 is a 16-bit integer that is mapped between 0 and 65535 for 33 elements, which are represented by 33 columns. The first column 411 represents the harmonic current command at zero degrees of rotation, and the thirty-third (last) column 413 represents the harmonic current command at 360 degrees of rotation, and is the same as the first column 411 to represent a periodic signal. The Kₚ gain term is to re-map the rotor position θ to present the periodic signal. When Kₚ=2, the table can represent the current harmonic from 0 to 180 degrees of the electrical position θ, which repeats for 180 degrees to 360 degrees. In order to minimize the table size, Kₚ can be selected as the greatest common divisor (GDC) of all the harmonic orders of interest. The Kₙ term compensates the effect of the motor speed, which can result in the lagging in the response. The θ_{offset} term compensates for the mismatch of the reference frame between the calibrated value and an actual rotor position of the electric machine 10.

The Y-axis 420 includes the first row 422, which represents the harmonic current command at negative maximum torque (TrqCmd=Tmin) at various rotor positions, and the last row 424 represents the harmonic current command at the maximum torque (TrqCmd=Tmax). Row 26 423, i.e., the middle row represents the harmonic current command at zero torque command. Y input is determined by the torque command as following:

(Y axis input)=KₜT_{cmd} [3]

wherein Kₜ is a gain factor to scale the torque command input, and
T_{cmd} is a torque command input.

The Y axis input scale, Kₜ adjusts for the difference between the actual maximum torque and the torque value from the FEA simulation.

The output of the table is scaled by the Kᵢ gain factor, in order to provide flexibility to the compensation (430). Moreover, the output value is multiplied with the gain dependent on the speed by 60 of FIG. 1. At low speed, the compensation works well because the current controller 20 is able to track the harmonic current command from the torque ripple mitigation calibration table 400. The compensation may degrade as the speed increases due to the limited control bandwidth. In order to avoid such a control degradation, the torque ripple mitigation calibration table 400 may not be employed at higher speeds.

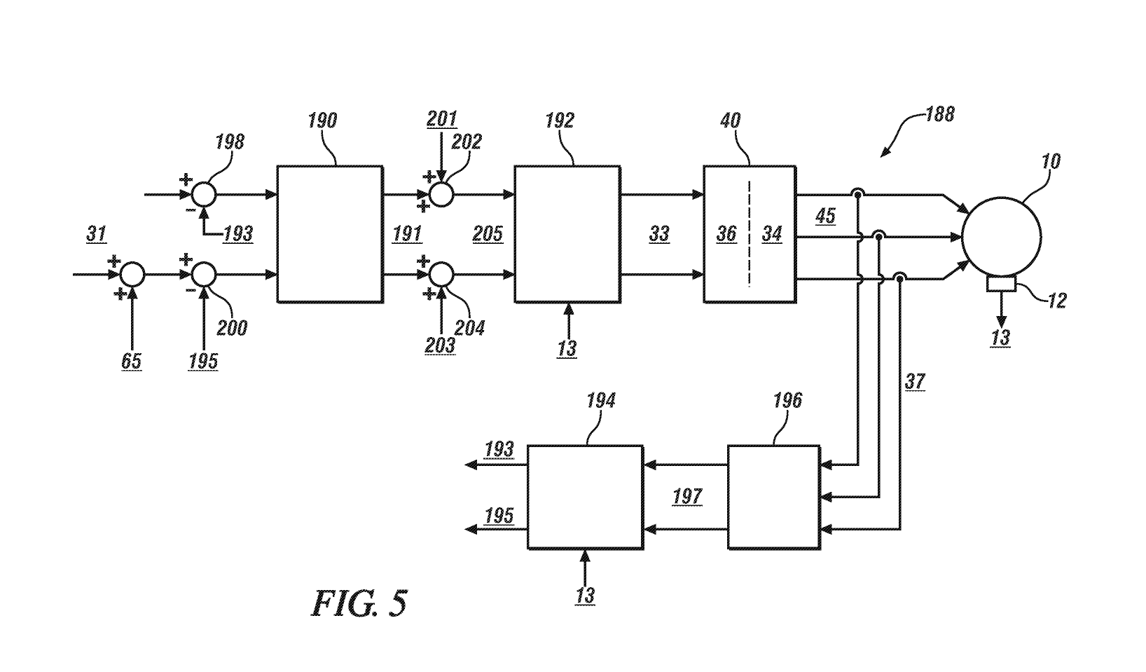

FIG. 5 illustrates an electric machine drive system 188 to dynamically control operation of an embodiment of the inverter 40 electrically connected to the electric machine 10 employing an embodiment of the torque ripple mitigation calibration process 300 described with reference to FIG. 3. The electric machine drive system includes a current controller 190, rotational transformation routines 192 and 194, a phase conversion routine 196, inverter 40 including a two-to-three phase conversion routine 36 and a PWM generation routine 34, the electric machine 10, the position and speed sensor 12, and summing elements 198, 200, 202 and 204. The electric machine drive system 188 is preferably executed as one or more routines in the inverter 40. The speed sensor 12 monitors the rotor position θ 13.

In operation, a torque command is sent from a high level controller, such as a torque controller or a vehicle controller. The torque command is transformed into current commands, i*_{sd} and i*_{sq}, which are DC quantities. The current commands, i*_{sd} and i*_{sq} represent the initial current command 31 described with reference to FIG. 1.

Phase conversion routine 196 transforms three-phase currents that are provided as feedback from the electric machine 10 into two-phase currents i_{α}(k) and i_{β}(k) 197. The rotational transformation routine 194 provides the rotational transformation (e.g., stationary to synchronous frames) with respect to the rotor position θ 13 obtained from the sensor 12 in order to change the two-phase AC currents, i_{α}(k) and i_{β}(k) 197 into two-phase DC currents, i_{sd} 193 and i_{sq} 195 which are used as current feedback at summing elements 198 and 200, respectively. The speed-compensated mitigation current command 65 is also added to the current command i*_{sq} at summing element 200, wherein the speed-compensated mitigation current command 65 compensates for the expected torque ripple from the electric machine 10, as described herein.

The difference between the current command and the current feedback drives the current controller 190 to generate feedback voltage commands, v*_{sd(fb)} and v*_{sq(fb)} 191, which are combined at summing elements 202 and 204 with feedforward terms v*_{sd(ff)} 201 and v*_{sq(ff)} 203 to determine commands v*_{sd} and v*_{sq} 205. This action decouples the voltage induced by the flux inside the electric machine 10 at the output of the current controller 190. The feedforward terms 201 and 203 are calculated from the flux table, Ψ_{d} and Ψ_{q}, as follows:

v*_{sd(ff)}=−ωᵣΨ_{q}(i_{sd},i_{sq}) [4]

v*_{sq(ff)}=−ωᵣΨ_{q}(i_{sd},i_{sq}) [5]

Although the commanded currents may be used in Equations 4 and 5, the decoupling voltages calculated using the commanded currents may result in an oscillatory current control response at high speed operation.

Three-phase AC voltage may be employed to drive the electric machine 10, so an inverse-rotational transform (e.g., synchronous to stationary frames) from commands v*_{sd} and v*_{sq} 205 to v*_{α} and v*_{β} 33 with respect to the rotor position θ 13 is performed by rotational transformation routine 192. These two-phase AC voltage commands, v*_{α} and v*_{β} 33 are transformed into three-phase AC quantities that are transformed to the PWM voltage commands 45 in the form of vₛₐ, v_{sb}, and v_{sc} by the PWM generation routine 34. The PWM voltage commands 45 vₛₐ, v_{sb}, and v_{sc} are communicated to the electric machine 10 to control operation thereof, and PWM current signals 37 in the form of iₛₐ, i_{sb} and i_{sc} are provided as feedback to routine 196.

The process and system described herein employ results from FEA simulation to modulate a motor current command in relation the motor torque command and the rotor position θ 13. The use of a two-dimensional compensation component allows for improved compensation over the entire torque envelope to provide a maximum torque per ampere output from the electric machine 10. As such, the torque ripple mitigation calibration process 300 described herein advantageously acts to suppress torque ripple that may include torque perturbations associated with multiple harmonic frequencies at rotor positions of an electric machine. The operation may not be applicable at higher motor speeds on some applications.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. A method for controlling a multi-phase electric machine electrically connected to an inverter, the method comprising:
determining an initial current command responsive to a torque command for the electric machine;
determining an expected torque ripple associated with operation of the electric machine;
determining a mitigation current command based upon the torque command and the expected torque ripple; and
dynamically controlling the electric machine responsive to the initial current command and the mitigation current command.

2. The method of claim 1, wherein the expected torque ripple includes torque perturbations associated with multiple harmonic frequencies at a rotor position of the electric machine.

3. The method of claim 1, wherein determining the expected torque ripple associated with operation of the electric machine comprises:
developing a finite element model of the electric machine;
simulating operation of the electric machine employing the finite element model; and
determining the expected torque ripple associated with operation of the electric machine based upon the finite element model.

4. The method of claim 1, further comprising determining the mitigation current command based upon the torque command and the expected torque ripple, wherein the expected torque ripple is determined based upon a rotational speed and a rotor position of the electric machine.

5. The method of claim 4, wherein determining the mitigation current command based upon the torque command and the expected torque ripple comprises developing a torque ripple mitigation calibration including a plurality of mitigation current commands that are selectable based upon motor position and torque command.

6. The method of claim 1, wherein dynamically controlling the electric machine responsive to the initial current command and the mitigation current command comprises adjusting the initial current command based upon the mitigation current command, wherein the mitigation current command is determined based upon the torque command and the expected torque ripple.

7. The method of claim 1, wherein dynamically controlling the electric machine responsive to the initial current command and the mitigation current command comprises controlling operation of the inverter to generate pulsewidth-modulated commands for controlling the electric machine, wherein the pulsewidth-modulated commands are responsive to the initial current command and the mitigation current command.

8. A method for controlling a powertrain system including a multi-phase electric machine electrically connected to an inverter in response to a torque command, the method comprising:
determining an initial current command responsive to the torque command;
determining an expected torque ripple associated with operating the electric machine in response to the torque command;
determining a mitigation current command based upon operating the electric machine in response to the torque command and the expected torque ripple; and
employing a feed-forward routine to dynamically control the inverter responsive to the initial current command and the mitigation current command.

9. The method of claim 8, wherein the expected torque ripple includes torque perturbations associated with multiple harmonic frequencies at a rotor position of the electric machine.

10. The method of claim 8, wherein determining the expected torque ripple associated with operation of the electric machine in response to the torque command comprises:
developing a finite element model of the electric machine;
simulating operation of the electric machine employing the finite element model; and
determining the expected torque ripple associated with operation of the electric machine based upon the finite element model.

11. The method of claim 8, further comprising determining a mitigation current command based upon operating the electric machine in response to the torque command and the expected torque ripple, wherein the expected torque ripple is determined based upon a rotor speed and a rotor position of the electric machine.

12. The method of claim 11, wherein determining the mitigation current command based upon the torque command and the expected torque ripple comprises developing a torque ripple mitigation calibration including a plurality of mitigation current commands that are selectable based upon motor position and torque command.

13. The method of claim 8, wherein dynamically controlling the electric machine responsive to the initial current command and the mitigation current command comprises adjusting the initial current command based upon the mitigation current command, wherein the mitigation current command is determined based upon the torque command and the expected torque ripple.

14. The method of claim 8, wherein dynamically controlling the electric machine responsive to the initial current command and the mitigation current command comprises controlling operation of the inverter to generate pulsewidth-modulated commands for controlling the electric machine, wherein the pulsewidth-modulated commands are responsive to the initial current command and the mitigation current command.

15. A powertrain system, comprising:
an inverter module including an inverter electrically connected to a multi-phase electric machine, the inverter module including executable code for dynamically controlling operation of the inverter, the code operative to:
determine an initial current command responsive to a torque command,
determine an expected torque ripple associated with operating the electric machine in response to the torque command,
determine a mitigation current command based upon operating the electric machine in response to the torque command and the expected torque ripple, and
employ a feed-forward routine to dynamically control the inverter responsive to the initial current command and the mitigation current command.
